(19) United States
(12) Patent Application Publication
(10) Pub. No.: US 2011/0055061 A1
(43) Pub. Date: Mar. 3, 2011

(54) Method and system for retaining customers with interrupted payment streams

(75) Inventor: Jonathan Yee, Wilton, CT (US)

(73) Assignee: American International Group, Inc., New York, NY (US)

(21) Appl. No.: 12/547,318

(22) Filed: Aug. 25, 2009

(51) Int. Cl. G06Q 10/00

(52) U.S. Cl. 705/34

(57) ABSTRACT

A method and system for retaining customers with interrupted payment streams includes identifying an at-risk-for-lapse customer based on at least one failed billing attempt. The at-risk-for-lapse customer by use of at least one communication channel. A billing information database is updated with updated billing information provided by the at-risk-for-lapse customer as a result of the communication, and a transaction record, which is indicative of the failed billing attempt, is recorded in a transaction history for future reference. This method is enabled by use of a specialized software application capable of retrieving, analyzing, and storing customer information from a central database. The software application is capable of identifying the at-risk-for-lapse customer based on certain factors, as well as selecting an appropriate customer contact strategy.

### BACKGROUND OF THE INVENTION

The direct marketing of accident and health insurance, especially through affinity marketing to customers and members of financial institutions, has historically been a business having a high customer turnover rate. Individual policy owners will frequently cancel coverage for various reasons, including rate shopping with competing carriers, personal financial concerns or hardship, or other changing consumer needs.

In operating such a business successfully, a coverage provider can typically provide easy access to information regarding the policy to the customers, for example, through customer contact centers, which customers may use to initiate claims, make inquiries about their coverage, or to cancel coverage. Consumers calling to cancel coverage (which is also known as voluntary cancellation) is the most common method by which the customer relationship ceases, and coverage terminates. Less frequently, a coverage relationship may cease when coverage for a customer lapses due to non-payment of insurance premiums. This type of lapse is typically known as an involuntary cancellation of coverage.

In the direct marketing and affinity marketing industries, customers are frequently billed on a regular, periodic basis by a debit to an account of the customer, for example, credit card, demand deposit account, mortgage account, or similar accounts. Customer account information is initially provided by the customer and remains on file with the carrier or administrator. Alternatively, certain customers may remit periodic payments via mail, internet, or phone prompted by pre-provided payment books, coupons or mailed invoice.

In any payment arrangement, the insurance coverage lapses when a due payment is not remitted or cannot be debited based on account information on file with the carrier. In the consumer-based direct marketing business, and in other similar business models, consumer products with recurring, periodic scheduled payments for the product, such as an insurance policy, for example, can lapse because the fee that is then due cannot be charged to the customer's billing information on file with the provider.

### BRIEF SUMMARY OF THE INVENTION

The proactive retention initiative disclosed herein advantageously provides the carrier with the ability to reconnect with customers and ask them to provide alternate billing methods when the billing methods on file are not adequate for providing the carrier with the premium payments that become due. Such ability can provide continued coverage on policies that may otherwise have lapsed. The disclosure additionally provides the ability to provide former customers, whose policies have unintentionally lapsed, with the ability to revive and continue coverage. In one general aspect, the disclosure provides a system and method of identifying customers whose policies may lapse within a predetermined amount of time if payment is not received, and a system and method of reconnecting with such customers in time before the policy lapses such that involuntary or unintentional lapses may be avoided. In avoiding unintentional policy lapses, the turnover of customers may be reduced, thus reducing the cost of providing continuing coverage to the business as well as building and maintaining a stronger relationship with the customer base.

In one aspect, the disclosure describes a method and system for retaining customers with interrupted payment streams. An at-risk-for-lapse customer can be identified based on at least one failed billing attempt. The at-risk-for-lapse customer can be contacted by use of at least one communication channel. A billing information database is updated with updated billing information provided by the at-risk-for-lapse customer as a result of the communication, and a transaction record, which is indicative of the failed billing attempt, is recorded in a transaction history for future reference.

In another aspect, a system for retaining at-risk-for-lapse customers is described. The system includes a provider processor operably connected to an electronic storage device, which includes an information database. A postal mail generation device and a telephonic communication device for providing channels of communication with customers can be provided. A bank processor is in operable arrangement with the provider processor for exchange of financial information. The provider processor is adapted to retrieve customer billing information from the information database and to generate a payment order based on the customer billing information. The payment order is submitted by electronic means to the bank processor for payment. An at-risk-for-lapse customer is identified when the payment order is refused by the bank. Thereafter, communication with the at-risk-for-lapse customer is initiated through the provider processor by: an electronic message sent to the at-risk-for-lapse customer using an electronic contact information entry stored within the information database, a postal mail letter generated by the postal mail generation device and sent to a mailing address of the at-risk-for-lapse customer stored within the information database, and/or an outbound telephonic connection between a customer service representative and the at-risk-for-lapse customer using the telephonic communication device and telephone contact information of the at-risk-for-lapse customer stored within the information database.

### BRIEF DESCRIPTION OF THE DRAWINGS

FIG. 1 is a flowchart of an embodiment of a method of identifying and contacting customers in accordance with the disclosure.

FIG. 2 is a block diagram of an embodiment of a system in accordance with the disclosure.

FIGS. 3-7 are visual representations of embodiments of various graphical user interface displays of a customer service application in accordance with the disclosure.

### DETAILED DESCRIPTION OF EMBODIMENTS OF THE INVENTION

The disclosure relates to a proactive retention method and system which uses a multi-touch, multi-channel approach to deliver a high-quality customer experience and increase customer lifetime value. By practicing these methods and systems, a company can identify customers who are likely to lapse for non-payment and utilize various approaches to lengthen the customer relationship through early identification. The process includes proactively contacting the identified customers to maintain their product in good standing.

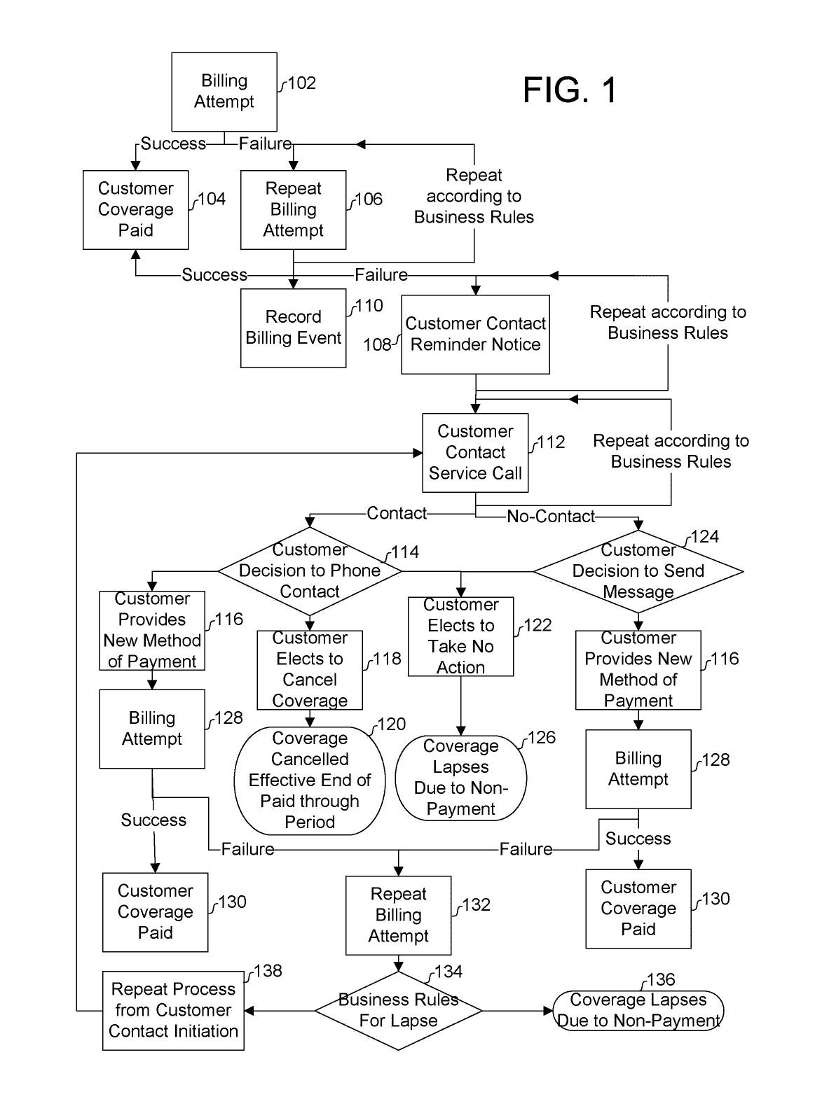

Referring to FIG. 1, an embodiment of a method of proactively retaining customers in accordance with the disclosure can begin with each periodic billing attempt for collection of premiums on an insurance product provided to each customer. A billing attempt is made at step 102, which will ordinarily debit an amount equal to the premium payment due for a period for the customer's product. The billing attempt at 102 may be conducted based on billing information that is on file with the provider, which may include credit card information, bank account routing information, electronic funds transfer information, and so forth.

The attempt to bill the customer at 102 may result in a successful payment, in which case the coverage for the customer is considered paid and up to date at step 104, and the process ends. However, if the billing attempt fails, for example, due to insufficiency of funds, outdated billing information or billing information that is no longer active or valid, or for any other reason, then the process continues with a repeated billing attempt at step 106, which may be repeated, for example, three times, as specified by the predetermined business rules of the provider that are applicable to the particular customer in question. A failure of the initial billing attempt at step 102 may also serve as an indication that the customer is at risk of lapse.

The business rules specifying the billing re-attempt strategy may be customized to suit the business as well as various customer segments. The business rules are a variable aspect of the proactive retention process described herein. Billing rules may cover a range of in which at one end of the spectrum are more re-attempts at billing and less reliance on custom contacts, and at the other end of the spectrum are fewer billing re-attempts and an earlier and greater reliance on customer contact to secure a new or alternative billing vehicle. Application of these billing rules can be determined by a multitude of factors including the business needs and preferences of partners (i.e., the financial institution or affinity group to which these customers belong), and the amount of expense that is sustainable for a given customer segment.

Customers can be segmented for handling through different processes in the proactive retention method. Customer segmentation can be used to determine:

1. Whether or not to apply the proactive retention process at all.

2. Which billing attempt strategy to utilize for a given customer segment.

3. What contact strategy to apply to a particular group or segment.

4. What message content to utilize for mail/email contact attempts.

5. What scripting to utilize for telephonic contact attempts.

Customers can be segmented using any appropriate criteria. In some embodiments, customers can be segmented by one or more of the following criteria:
Financial institution or affinity group membership
Group preferences (which may related to above referenced group membership)
Customer's preferred contact method
Tenure as a customer
Price point and profitability of coverage purchased

In some embodiments, billing reattempts may be classified as aggressive, moderate, and light. For example, an aggressive billing reattempt can include as many as four attempts to bill a customer's credit card for each of two successive months before reverting to a customer contact, or two to three attempts to bill to a bank account of a customer (e.g., to make an ACH withdrawal from a checking account) in each of two months. An example of a moderate billing reattempt strategy, which may be typically employed as the default strategy in the absence of factors indicating a need to change, includes between three and four billing attempts to the credit card of a customer in a single month, or no more than two attempts to bill the bank account of the customer, followed by direct customer contact. An example of a light billing reattempt includes one or two attempts to bill the credit card of a customer contact, or alternatively a single attempt to bill the bank account of the customer, followed by an attempt to contact the customer to secure a new payment mechanism.

Overall, an initial billing failure initiates the proactive retention process for customers who are at risk of lapse. Such customers can be identified as a result of multiple unsuccessful billing attempts (referred to as ‘hard declines’), which will have the customer record marked for inclusion in the proactive retention process. Identification of such customers can occur earlier based on certain factors, such as receipt of or identification of invalid billing information, inclusion of the customer in an at-risk customer segment based on past billing history, the customer opting out of an automatic payment election, impending expiration of billing information on file, and others.

Returning now to the flowchart of FIG. 1, successful payment after one or more repeated billing attempts at 106 may result in successful payment, in which case the coverage is considered up to date at 104. The performance of one or more repeated attempts for payment, regardless of outcome, may be recorded as part of the customer's billing history at step 110.

When billing attempts have failed, a customer is identified at being at risk for lapse. The next major step in the proactive retention process is the initiation of contact with the customer, such as the reminder notices that may be sent to the customer at step 108. A customer contact action may be initiated at step 108 in the form of a payment reminder.

The contact channel, the sequence of communications, message content, and the timing and frequency of contact attempts may vary based upon several criteria established as predetermined business rules. In general, the strategy followed when contacting the customer, not only for payment reminders, but for most other types of customer communication as set forth herein, may be conducted in consideration of fewer or more factors that are relative to the particular attributes of each individual or group of clients.

Factors related to the customer communication strategy may include preferred contact channels as that specified by an individual or a group of customers, the affinity relationship between the provider and the customer, contact preferences set at a group level such as those groups having institutional sponsors, the allowable expense spent in contacting the customer, which may be based, for example, on the history of the customer or the price point of the customer's product, the longevity of the customer as a holder of the product, the policy premium amount, and others.

One or more contact attempts reminding the customer of the payment that is or will become due can be conducted at step 108. These reminders may or may not result in payment from the customer. If payment is received, the process can terminate until the next payment becomes due.

In the event that a payment remains unsatisfied following the reminders, a customer contact service call may be performed by the provider at step 112, which may be repeated according to the rules of the business as previously discussed. The customer service call at step 112 may be performed using one or more contact channels according to the contact strategy associated with the particular customer based upon the predetermined business rules. For example, a minimal contact approach may only include one contact channel and fewer attempts at contact, while a more robust contact strategy, which may be driven by the aforementioned criteria, may include multiple contact channels used sequentially or simultaneously, and multiple attempts at customer contact. Regardless of the aggressiveness of the approach employed, the contact channels that may be used include postal mail, electronic mail (or email), and telephone contact.

Postal mail contact with the customer includes one or more reminder and/or billing notices specifically tailored for each customer to include message content describing a specific scenario. Such proactive retention billing notices will typically have a progression from a first notice to second and possibly third notice, with message content that expresses increasing urgency. The final contact to most customers will take the form of a final lapse notification sent to customers via postal mail, if previous contact attempts have been unsuccessful.

Contacting a customer via mail can serve a dual purpose as both a reminder for payment, as well as a method for collection of payment. Customers can review the details of their policy with the option of submitting payment via credit card or a direct debit account (DDA) by mailing back a form attached to the notice. An inbound call can be generated as well from a mail piece for customers who have questions before submitting payment. An aggressive mail approach will include as many as three mailed notices, preferably applied to more profitable customer segments or customers with longer policy tenure.

Email contact with the customer, in a fashion similar to postal mail, may include one or more reminder and/or billing notices to customers, with message content which is tailored to the specific scenario. Message content will typically increase in urgency through the progression of first to second and third contact attempts.

In addition to the passive customer contact methods, such as postal mail or email, telephone contact may be conducted in certain cases. For customers with whom a more aggressive billing strategy has been used, the final contact strategy to secure a new billing method can be by telephone. In this case, multiple attempts to bill have already been made and the final attempt before canceling a policy can be made by a live agent who can review the policy details with the customer in an effort to retain the business. During a contact by telephone, a call is initiated to one or more telephone numbers on file for the customer. Telephone contact can include several variations, with differential scripting being driven by available data. For example, the telephone scripting for an outbound telephone call to the customer may be tailored to include scripting based on the customer's tenure and the reason for payment processing failure.

The main objective of such customer service call attempts at step 112 is to secure an alternative billing vehicle which can be used for future recurring billing. An additional benefit of the process for both the company and the customer is the delivery of a high quality customer experience, in which the company demonstrates a clear desire to engage the customers and proactively ensure their engagement and awareness of their policy status. However, the proactive retention process disclosed herein is versatile and recognizes that one strategic approach does not satisfy the individual requirements, needs, and expectations of all customers. A specialized process employing differential attempt timing, varying messages, and unique customer modeling tools is incorporated into the method to further enable the effective utilization of such a strategy.

The attempts for customer contact at step 112 may be successful in providing direct contact with the customer using any of the communication channels described above. When the customer is reached by the telephone at step 114, a representative of the provider may inform the customer of the failure to charge the customer for the most recent recurring payment and determine whether the customer wishes to continue with the coverage provided under the product. In response, the customer may elect to continue coverage and provide new or updated payment information at step 116. Alternatively, the customer may elect to cancel the coverage at step 118, in which case the provider cancels the coverage with an effective cancellation date of the last day of the period that has previously been paid for, if applicable, at step 120.

An alternative customer response is an election of the customer to take no action at step 122. Such election may be express when directly in contact with the customer, or may be assumed from a message sent by the customer at step 124 in the case no direct contact by phone at step 114 is possible. Regardless of origin, a lack of action by the customer at 122, in the absence of updated or new billing information by which to secure payment, will cause the coverage to lapse due to non payment at step 126.

New or updated billing information provided by the customer at step 116, whether such information is provided telephonically at step 114 or by message at step 124, will prompt a billing attempt or payment method verification by the provider at step 128. Success of the billing attempt or successful verification of validity of such billing information provided at step 128 will end the process at 130 with the coverage for that particular customer being considered valid, paid, or active as appropriate. However, failure of the billing attempt using the new or updated billing information received by the customer will lead to a single billing reattempt at 132, as previously described.

When the final billing reattempt at step 132 leads to failure of payment, a decision is made at step 134 of the appropriate disposition of the matter based on the rules of the particular business. In some instances, the coverage is allowed to lapse due to non payment at step 136. For certain clients having a long history with the provider or owning other products with the provider, the decision can be made to repeat the customer contact initiation process at step 138, and the process repeats at step 112 with a renewed attempt for customer contact and placement of a service call.

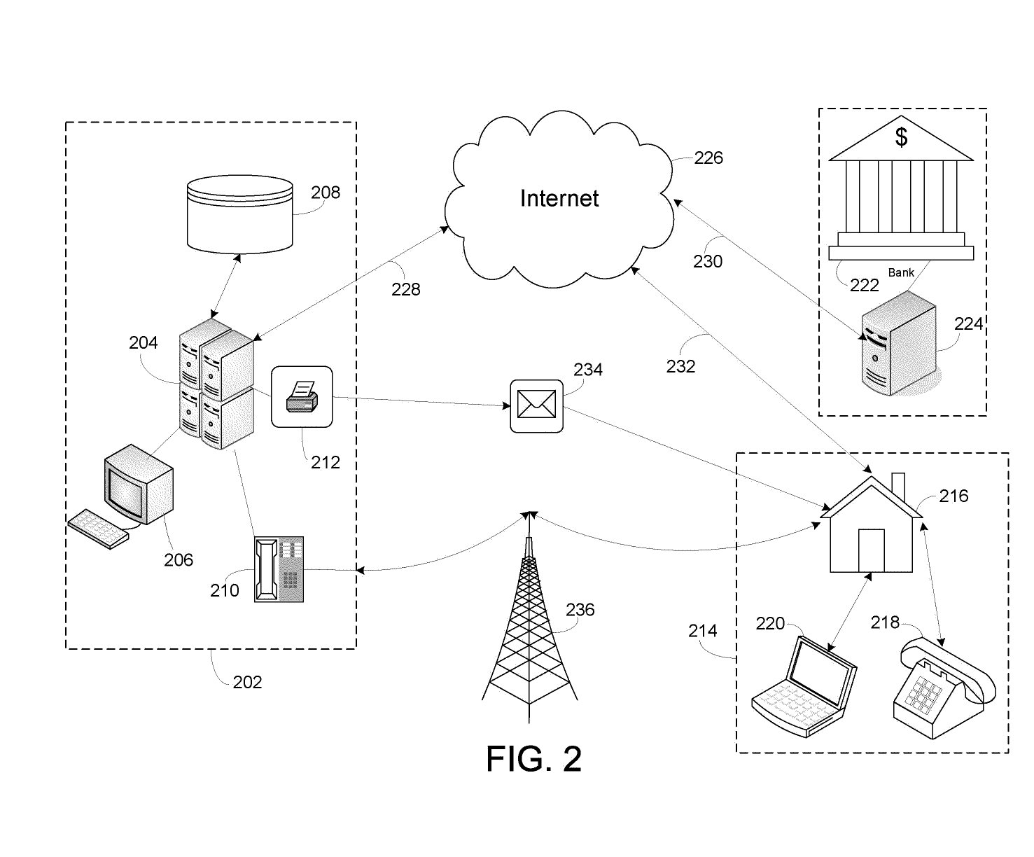

The proactive retention process relies on several software applications which enforce business rules and apply certain logic to provide various determinations, such as how to segment customers for effective and efficient handling, apply best practice billing rules to optimize the efficient collection of premium with the least possible amount of manual or human intervention, apply contact strategies effectively to retain customers who would otherwise attrite due to non-payment of premiums due, and others. Such software applications are stored and executed on one or more computers or processors of the provider, which are part of a larger system that integrates communications with the customers and other entities, such as banking and other financial institutions. A block diagram of a such a system is illustrated in FIG. 2.

FIG. 2 is a block diagram of a system that includes computer, mail, telephone, and payment resources for use by a provider in proactively retaining customers in accordance with the disclosure. As shown in the figure schematically, a provider 202 may have facilities that include a computer processor 204 connected with workstations or terminals 206. Users operating the terminals 206, as well as other, automated functions of software operating within the processor 204 have access to electronic storage devices 208 having stored therewithin databases of customer information. Such customer information is accessible to the users via the terminals 206, as well as available for use by the specialized software applications operating in the processor 204.

The provider 202 further includes facilities for telephone communication, such as telephones 210, which can be available to the users of the terminals 206, and postal mail generation devices 212, such as printers, for example. The telephones 210 may operate in concert with the processor to automatically dial customers and route answered calls to users at the same time as specialized information about the account of the customer answering the call is displayed on the monitor of the terminal 206 of the user to which the call is routed. The postal mail generation facilities 212 may be associated with the processor 204 and arranged to print, sort, and mail letters containing specific customer information and tailored messages that are provided from specialized software applications operating within the processor 204.

The system further includes a customer 214, whose residence is schematically represented as a house 216, which symbolically represents the customer's preferred address provided when purchasing coverage. For the sake of the present discussion, the customer 214 possesses the capability of telephonic communication, via a telephone 218, electronic communication, via a computer 220, and postal mail communication, via a physical mailing address represented by the house 216. Lastly, the system further includes a bank 222 or other type of financial institution, e.g., a credit card company, having a computer processor 224 associated therewith.

As previously described, the proactive retention process of the provider 202 includes a billing attempt, for example, the billing attempts performed at steps 102, 106, 128, and 132 shown in the flowchart of FIG. 1. In one embodiment, such billing attempts are performed electronically between the processor 204 of the provider 202 and the processor 224 of the bank 222 via the Internet 226, which is shown symbolically as a network cloud. More specifically, when the provider 202 desires to perform a billing transaction, appropriate computer executable instructions are performed in the processor 204 based on customer information, such as the billing amount, date due, and billing information relative to a customer, which information is provided to the processor 204 by the storage device 208.

A payment order is thus generated by the processor 204, and sent electronically via a provider network conduit 228 connected to the Internet 226, through a bank network conduit 230 also connected to the Internet 226, to the processor 224 of the bank 222. The bank processor 224, which contains account information and balances of the customer, may send a message back to the processor 204 of the provider 202 by use of the conduits 228 and 230, which message may be indicative of the validity of the billing information used to generate the payment order, the availability of adequate funds to fulfill the payment order, confirmation of a fund transfer to a bank account of the provider 202 in response to the payment order or, alternatively, the failure to fulfill the payment order along with a reason for such failure.

As described relative to the process shown in FIG. 1, a failure to fulfill a payment due may generate billing reattempts, such as those performed at steps 106 and 132, each of which is conducted by generation and transmission of additional payment orders from the provider 202 to the bank 222. Moreover, records indicative of the state and outcome of transactions of the processor 204, such as the outcome of a payment order sent to the bank 222 as described relative to step 110 in the process shown in FIG. 1, may be recorded in the storage device 208 by the processor 204.

The provider network conduit 228 may additionally be used to conduct two way electronic communications via the Internet 226, for example, in the form of emails sent and received, with the customer 214. More specifically, the customer 214 may have an Internet connection 232 that is capable of receiving electronic communications sent from the processor 204 of the provider 202. These electronic communications, or emails, are received by the computer 220 of the customer 214, thus providing the capability to the customer to view them and respond to them. This form of communication may be part of the process shown in FIG. 1, for example, as part of step 108 for sending reminders to the customer, step 112 for contacting the customer, step 124 which enables the customer to send a message to the provider, and so forth.

Additional channels of communication are possible between the provider 202 and the customer 214. In addition to email or electronic communication, the postal mail generation devices 212 of the provider 202 may generate postal mail communication, which can be sent to the customer 214 by use of a postal authority 234. The postal authority 234 can deliver letters or other printed materials sent by the provider 202 to the mailing address specified by the customer 214.

An additional channel of communication is telephone communication. The provider 202 may initiate outbound calls to the customer 214 via the telephones 210 as previously described, which can connect a customer service representative of the provider to the customer 214 via a telephone communication infrastructure 236. One can appreciate that the telephone communication infrastructure 236 may be of any known form and configuration, such as land based, wireless based, and voice-over-internet-protocol (VOIP) based communications technology. In some embodiments, an automated call distributor using voice recognition and speech synthesis technology can be employed to deliver one of a set of scripted messages to an at-risk-for-lapse customer and to capture new payment information from the customer using a voice response unit using conventional equipment, such as those described, for example, in U.S. Pat. Nos. 6,546,087; 6,587,558; 6,771,746; and 6,904,143.

In reference to the process described relative to the flowchart of FIG. 1, the postal mail and/or telephone communications between the provider 202 and the customer 214 may be conducted during the client communication steps 108, 112, 114, and 124 shown and described previously.

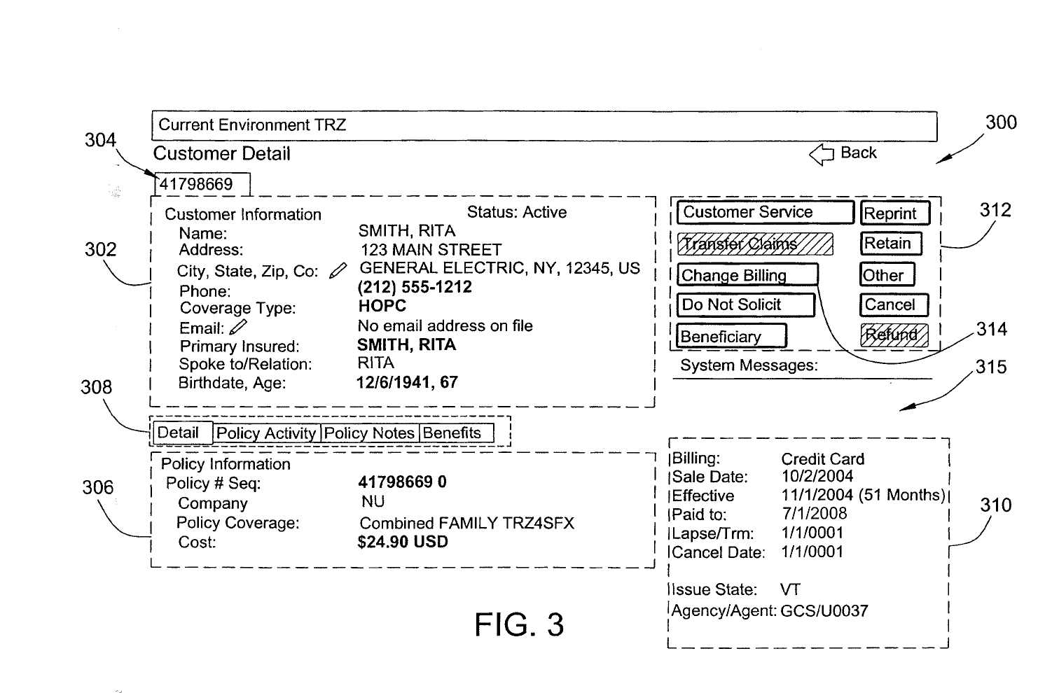

As previously discussed, specialized software applications operating in the processor 204 of the provider 202 may enable the effective process of customer retention. An exemplary embodiment of graphical user interface displays for such a software application is provided in FIGS. 3-7. The example illustrated in these figures provides the interface that is displayed on the workstation 206 and with which the user interacts to provides input information to the system during a telephone conversation with a customer providing updated billing information as described, for example, in steps 114, 116, and 128 of the flowchart of FIG. 1. As mentioned above, steps 114, 116, and 128 include the steps whereby a customer is in contact with the provider over the telephone, has elected to continue coverage, and is providing new or updated billing information, which is then verified by the provider.

FIG. 3 is an illustration of a main customer service screen 300. The main screen 300 may appear on the workstation when an automatically dialed call has been answered by a customer, and may display the customer's information to the customer service representative. The customer service representative may converse with the customer based on a script provided by another screen or window of the workstation (not shown) during the transaction with the customer. Pertinent information about the customer and the customer's account is displayed on the main screen to provide information to the customer service representative in answering questions by the customer during the call, as well as to enable the customer service representative to change or update relevant information as necessary.

More particularly, the main screen 300 includes a biographical information section 302 for the customer. The biographical information section may include personal information of the customer, such as name, mailing address, telephone and email contacts, the type of coverage purchased, as well as a status indicator of that customer's current coverage. An account tab 304 may display the account number for the particular product for which the customer is being contacted. In the case where the customer has more than one product with the provider, multiple account tabs 304 can be displayed. Selecting an account tab, can call up specific coverage information for the particular product selected. The information displayed in the biographical information section 302 of the main screen 300 may be automatically retrieved by the specialized software from the data storage device 208 shown in FIG. 2.

Specific and comprehensive information about the coverage purchased by the customer is shown in the coverage information section 306 of the main screen 300. Information included in the coverage information section 306 may include any pertinent information about the coverage, such as policy number; the customer's employer or other sponsoring entity, if any; the type of coverage; the cost of coverage; and other information. The coverage information section 306 may further include tabs 308 that can be selected to retrieve and display information incidental to the coverage, such as any activity logs relative to the policy, any notes the provider has recorded in the customer's file, benefit information paid or payable on the policy, and so forth.

Specific billing information of the customer is displayed in the billing information screen 310 of the main screen 300. The billing information screen 310 may include all pertinent billing information on file with the provider for the specific customer and/or for the specific product purchased by the customer, such as the type of billing vehicle to be used (e.g., credit card), the date of sale of the coverage, the effective date of the coverage, the payment period, and so forth. A comments section 315 displays status changes or other information about the account to the customer service representative.

The main screen 300 further includes a commands section 312. The commands section 312 includes a series of buttons which can be selected by the customer service representative during the telephone call with the customer to change or update information about the customer's coverage. Various commands may be conducted by selection of the appropriate button, such as updating of beneficiary information, placing customer on a do-not-call list, and so forth, and pertinent to the current discussion, the updating of the customer's billing information, which can be activated by selection of the appropriate button 314. By pressing the button 314, the customer service representative is taken to a screen for entering and verifying updated billing information provided by the customer during the telephone call.

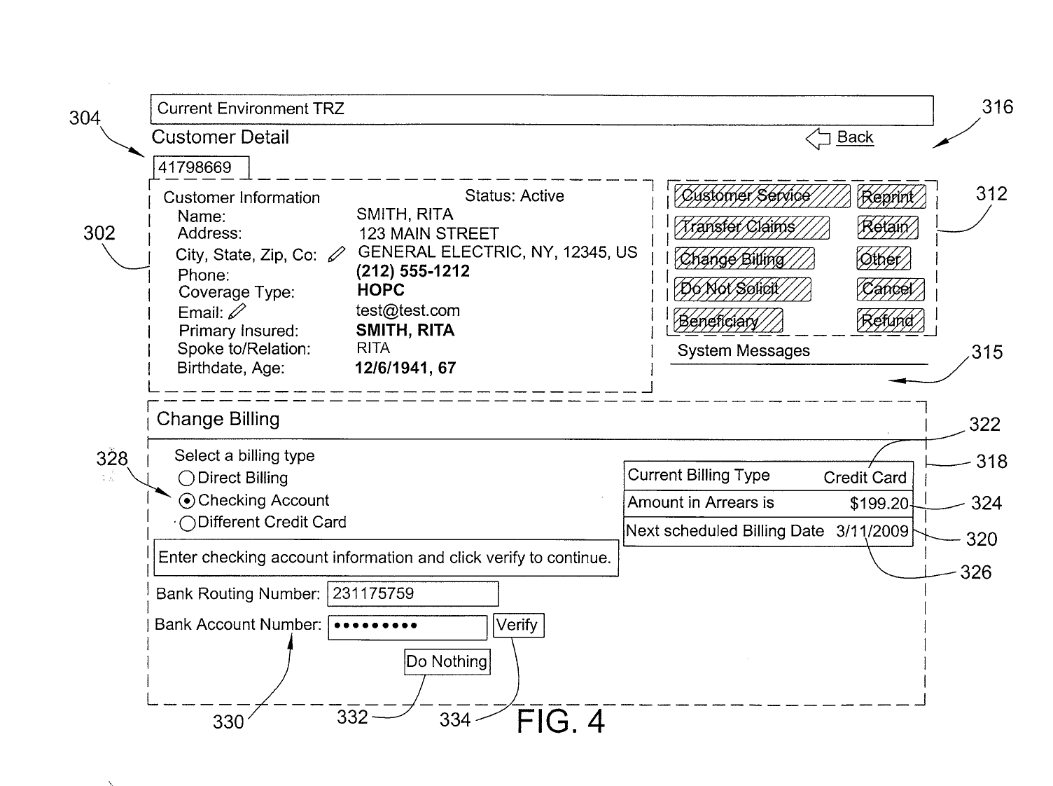

Referring to FIG. 4, after selecting the change billing button 314, a billing information screen 316 is displayed. The billing information screen 316 in the embodiment illustrated includes the biographical section 302, the account tab 304, and the commands section 312, in which all commands can appear but may not be selected while the billing information screen 316 is displayed because the system is in a data entry mode.

The billing information screen 316 primarily includes a billing data portion 318. The billing data portion 318 includes current billing information 320 of the customer, which is retrieved from the database of the provider and displayed for the convenience of the customer service representative. The current billing information 320 can include relevant information about the billing status of the customer, such as the current billing type 322 (e.g., credit card, bank account, etc.), outstanding balance or amount in arrears 324 of the customer, and the date when the next scheduled payment will become due 326.

The primary function of the billing information screen 316 is entry of new or updated billing information, which is provided by the customer during the telephone conversation with the customer service representative. Accordingly, when updating the billing information, the customer representative may select a billing type 328, for example, by selecting an appropriate radio button, and entering specific billing account information 330, such as a bank routing number and account number, in appropriate fields. When in this transaction, the customer service representative may elect to cancel the entry by selecting a button 332 or verify an entry by selecting a verify button 334.

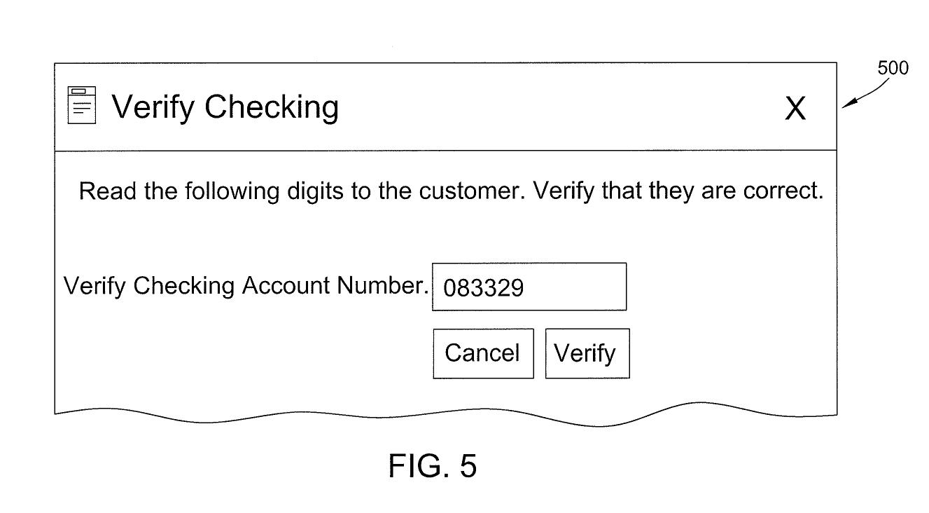

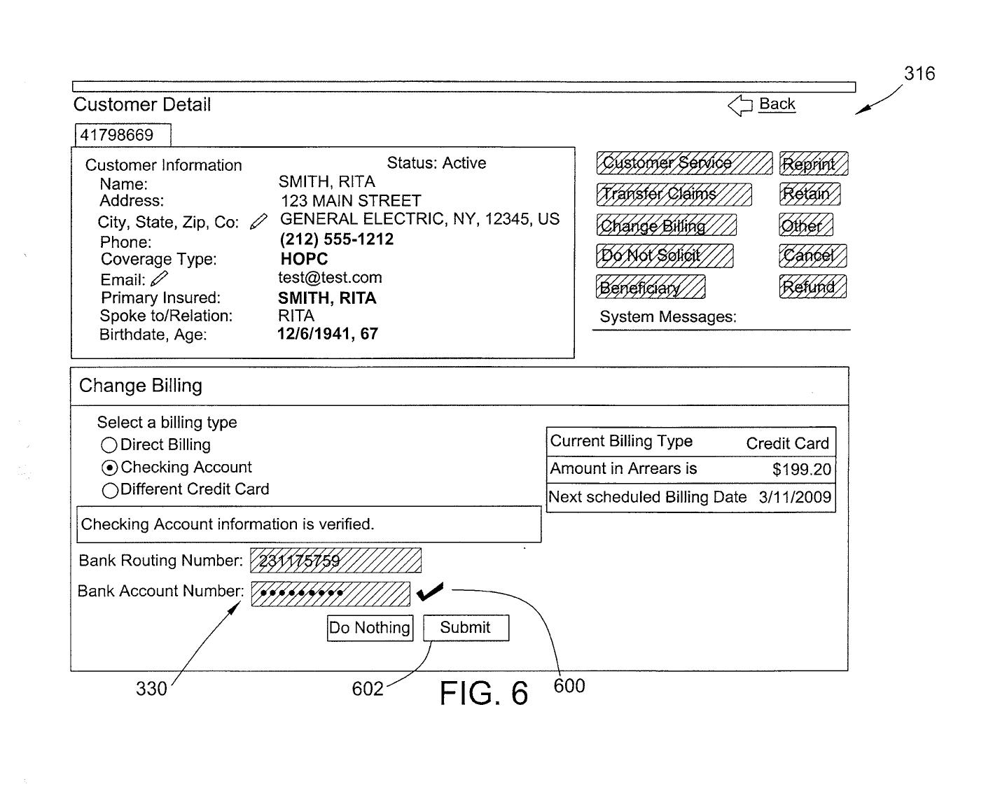

When verifying account information by selecting the verify button 334, intermediate windows can appear on the screen to aid the representative in checking the information provided by the customer before completing the transaction. One such screen is shown in FIG. 5, where a verification query 500 appears following selection of the verify button 334 in the billing information screen 316. The verification query 500 may include an instruction to the representative to read the digits of the account information provided back to the customer for verification, provide the stored account number information, and prompt the representative to either verify or reject the information. Upon appropriate selection by the representative, the billing information screen 316 will reappear, as shown in FIG. 6. In the case when the information provided by the customer has been verified, a check mark 600 will appear adjacent the billing account information 330 in the location where the verify button 334 was located prior to verifying the information (see, for example, FIG. 4), indicating that the account information has been verified. In one embodiment, the billing account information 330 may additionally or alternatively be verified directly with a banking institution, in real time, instead of or after the oral verification of the account number occurs between the representative and the customer.

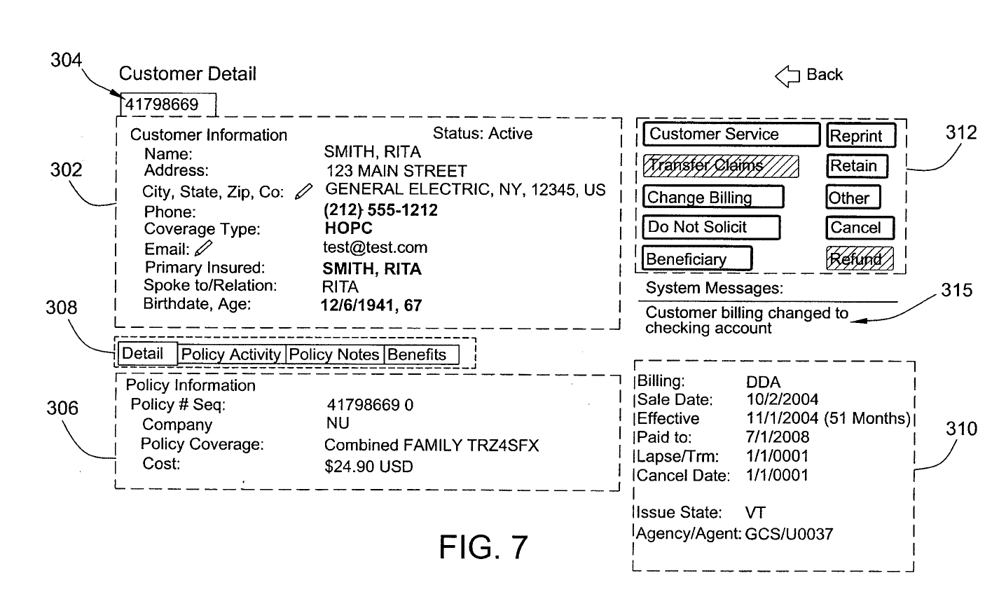

Having verified the account information, the representative is able to submit the new or updated account information by selecting a submit button 602, which has now also appeared in the billing information screen 316. When the selection of the submit button 602 has been made, the main screen 300 is displayed once more having a notation in the comments section 315 indicating that the system has been updated, as shown in FIG. 7.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for retaining customers with interrupted payment streams, comprising:
identifying an at-risk-for-lapse customer based on at least one failed billing attempt;
contacting said at-risk-for-lapse customer by use of at least one communication channel;
updating a billing information database with updated billing information provided by said at-risk-for-lapse customer;
recording a transaction record indicative of said at least one failed billing attempt in a transaction history for said at-risk-for-lapse customer.

2. The method of claim 1, wherein contacting said at-risk-for-lapse customer includes at least one of placing an outgoing telephone call using a telephonic contact information entry previously stored and retrieved from a database, electronically transmitting a letter using an electronic mail address previously stored and retrieved from the database, and generating and transmitting a printed letter using information previously stored and retrieved from the database.

3. The method of claim 1, wherein identifying the at-risk-for-lapse customer includes attempting to bill said customer using previously stored and retrieved billing information from a database.

4. The method of claim 1, wherein updating the billing information database includes using a specialized software application including computer executable commands for retrieving customer information from a customer database, displaying said customer information on a screen associated with a workstation, and executing computer executable commands for storing updated information into said billing information database, wherein said workstation is operably connected to a processor, the processor being associated with a memory storage device having said billing information database and said customer database stored therein.

5. The method of claim 1, further including determining a categorization of said at-risk-for-lapse customer based on at least one factor.

6. The method of claim 5, wherein said at least one factor is selected from the group consisting of a billing history, an opting out of automatic payment election, and an impending expiration of billing information on file, each of which has been previously recorded and retrieved from said billing information database.

7. A system for retaining at-risk-for-lapse customers, comprising:
a provider processor operably connected to an electronic storage device, the storage device having an information database stored therein, the information database including customer information including billing information and at least one of telephone, mail, and electronic mail contact information;
a postal mail generation device operably connected to the provider processor and adapted to generate printed matter containing a predetermined billing message;
a telephonic communication device;
wherein said provider processor is adapted to:
retrieve customer billing information from said information database;
generate a payment order based on said customer billing information;
submit said payment order by electronic means to a bank processor for payment;
identify an at-risk-for-lapse customer when said payment order is refused by said bank;
initiate communication with said at-risk-for-lapse customer using at least one of: an electronic message sent to said at-risk-for-lapse customer using an electronic contact information entry stored within said information database, a postal mail letter generated by the postal mail generation device and sent to a mailing address of said at-risk-for-lapse customer stored within said information database, and an outbound telephonic connection between a customer service representative and said at-risk-for-lapse customer using said telephonic communication device and telephone contact information of said at-risk-for-lapse customer stored within said information database.

8. The system of claim 7, wherein said provider processor is further adapted to execute computer executable instructions for retrieving information about said at-risk-for-lapse customer from said information database, displaying said information on a visual display device operably associated with said provider processor, accept manual information input from said customer service representative via an input device, and store updated information in said storage device.

9. The system of claim 7, wherein initiation of communication with said at-risk-for-lapse customer includes classifying said at-risk-for-lapse customer based on at least one of a billing history, an opting out of automatic payment election, and an impending expiration of billing information on file, each of which has been previously recorded and retrieved from said information database.
